(19) United States
(12) Patent Application Publication
(10) Pub. No.: US 2021/0166903 A1
(43) Pub. Date: Jun. 3, 2021

(54) ELCTRICAL CONTACTOR

(71) Applicant: SolarBOS, Inc., Livermore, CA (US)

(72) Inventor: Coel Schumacher, Auburn, CA (US)

(21) Appl. No.: 17/173,638

(22) Filed: Feb. 11, 2021

Related U.S. Application Data
(63) Continuation of application No. 16/157,667, filed on Oct. 11, 2018, now Pat. No. 10,950,402.
(60) Provisional application No. 62/573,286, filed on Oct. 17, 2017.

(51) Int. Cl. H01H 50/02; H01H 51/29; H01H 50/54; H01H 50/14

(52) U.S. Cl. CPC H01H 50/026; H01H 51/29; H01H 2239/018; H01H 50/14; H01H 50/546

(57) ABSTRACT

An electrical contactor, and more particularly, but not exclusively, contactors having improved noise performance.

### RELATED APPLICATIONS

This is application is a continuation of U.S. application Ser. No. 16/157,667 filed Oct. 11, 2018, which in turn claims the benefit of priority of U.S. Provisional Application No. 62/573,286, filed on Oct. 17, 2017, the entire contents of which application(s) are incorporated herein by reference.

### FIELD OF THE INVENTION

The present invention relates generally to electrical contactors, and more particularly, but not exclusively, to electrical contactors having improved noise performance.

### BACKGROUND OF THE INVENTION

Traditional contactor design is composed of three main parts: control circuitry, main contacts, and the mechanical housing. Typically the control circuitry is designed to avoid creating and/or inducing “noise” or other unwanted disturbances on the main contacts which may occur due to the windings of the electro-magnet that move the main contacts. The contactor may for instance may include a plunger that is electrically isolated from a contact bridging bar. (Gigavac, Model/PN: HX21CCC.) The ferrous parts (i.e., housing) of the contactor are typically not isolated from the main contacts. While ferrous parts are not isolated, they are also not intentionally connected. This allows ferrous parts to float at some voltage that may or may not be the same as the main contacts. Typically this is not a problem; however, if the main contact voltage fluctuates, it can change by enough (while the housing does not change with it) that at a certain point the potential between the two will be great enough for a spark (capacitive discharge) to jump and cause the housing voltage to jump to a voltage closer to that of the main contacts. This in turn can induce an unwanted voltage in the control circuit. Accordingly, there is a need in the art for contactors which avoid such problems.

### SUMMARY OF THE INVENTION

In one of its aspects, the present invention may provide an improved electrical contactor in which the control circuit is isolated from the main contacts/circuit and in which a ferrous housing and other related ferrous parts are shielded from one another. Such an arrangement may also help to keep the main circuit from interfering with the control circuit. In such a situation, the contactor housing may also be grounded. In another of its aspects the present invention may provide an electrical contactor in which the main contacts are absolutely isolated from the housing to keep the housing from changing voltage drastically and unpredictably with undesirable effects on the control circuit. Alternatively, a main contact bridging bar may be electrically connected to the housing. In yet a further of its aspects, the present invention may provide an electrical contactor in which the housing is electrically connected to one of the poles of the main contacts to ensure that the housing voltage is held at the voltage of the main contacts and does not change unpredictably. In so doing, the typical double break main contacts will only break on a single contact so it may be preferred that the connection between the selected contact pole and housing be made through a high resistance to regain the full functionality of the two breaking contacts.

In view of the above, in one of its aspects the present invention may provide an electrical contactor, comprising a housing and a pair of electrical contacts mounted thereto, each contact having an end extending into the housing. The contactor may include a contact bridging bar movably positioned relative to the pair of electrical contacts such that the contact bridging bar contacts and electrically connects the pair of electrical contacts in a first position of the contact bridging bar. The contact bridging bar may be disposed out of contact with the pair of electrical contacts in a second position of the contact bridging bar. A plunger may be attached to the bridging bar, and coil windings may be disposed about the plunger. The coil windings may be configured to generate a magnetic field operable to move the plunger between first and second positions corresponding to the first and second positions of the contact bridging bar. In addition, either i) the plunger and contact bridging bar may be electrically isolated from one another and the housing connected to ground or ii) the plunger or a selected one of the pair of electrical contacts may electrically communicate with the housing. The housing may include a lower compartment in which the coil windings are disposed, and the lower compartment may include a ferrous wall disposed between the coils and the pair of electrical contacts. The ferrous wall may have an aperture with the plunger disposed therein. A conductive spring or a flexible conductive member may be connected to the plunger and the housing to provide electrical communication therebetween. The plunger or a selected one of the pair of electrical contacts may electrically communicate with the housing which is connected to ground.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates an exemplary configuration of an electrical contactor in accordance with the present invention having a contact bridging bar electrically isolated from a plunger with the housing grounded;

FIG. 2 schematically illustrates a further exemplary configuration of an electrical contactor in accordance with the present invention having a plunger electrically connected to the housing; and

FIG. 3 schematically illustrates yet a further exemplary configuration of an electrical contactor in accordance with the present invention having a main contact electrically connected to the housing.

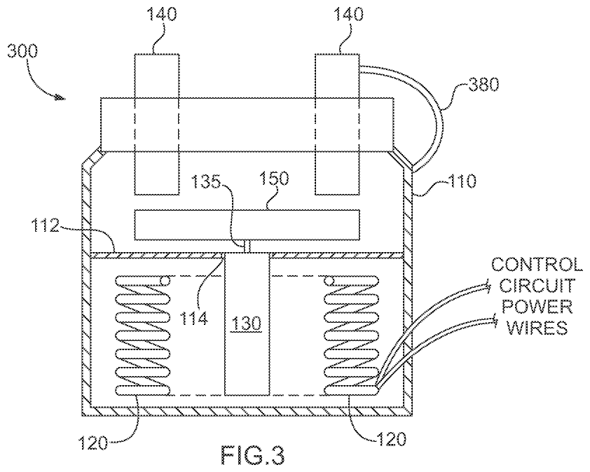

### DETAILED DESCRIPTION OF THE INVENTION

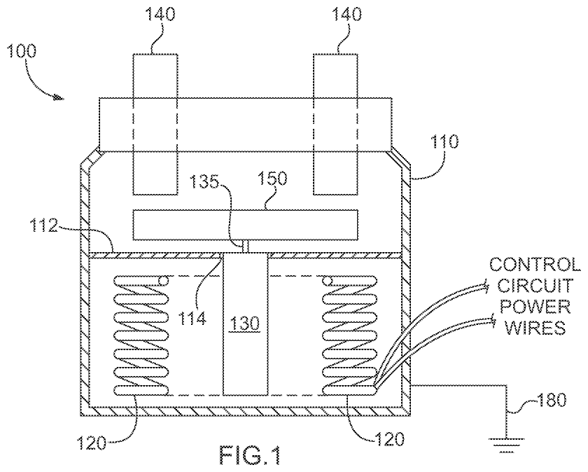

Referring now to the figures, wherein like elements are numbered alike throughout, FIG. 1 schematically illustrates an exemplary configuration of an electrical contactor 100 in accordance with the present invention. The contactor 100 may include a ferrous housing 110 having a lower compartment 116 defined by a ferrous wall 112 having an aperture 114 disposed therein. Coil windings 120 may be provided in the lower compartment 116 with a plunger 130 disposed between the coil windings and located within the aperture 114. The plunger 130 may be attached to a main contact bridging bar 150 via an electrically isolative material 135. The contactor 100 may also include a pair of main contacts 140. The plunger 130 may be configured to respond to a magnetic field created by the coil windings 120 to allow the plunger 130 to move between a first position and a second position within the housing 110. In particular, at a first position of the plunger 130, the main contact bridging bar 150 may be disposed in contact with the main contacts 140 to electrically connect the main contacts to one another. In a second position of the plunger 130, the main contact bridging bar 150 may be disposed out of contact with the main contacts 140 so the main contacts 140 are not in electrical communication with one another. The housing 110 may be grounded 180 to help ensure that the housing 110 stays at a constant voltage. By maintaining the housing 110 at a constant voltage and electrically isolating the main contact bridging bar 150 from the plunger 130, and thus the coil windings 120, extraneous electrical signals may be prevented from reaching the main contacts 140.

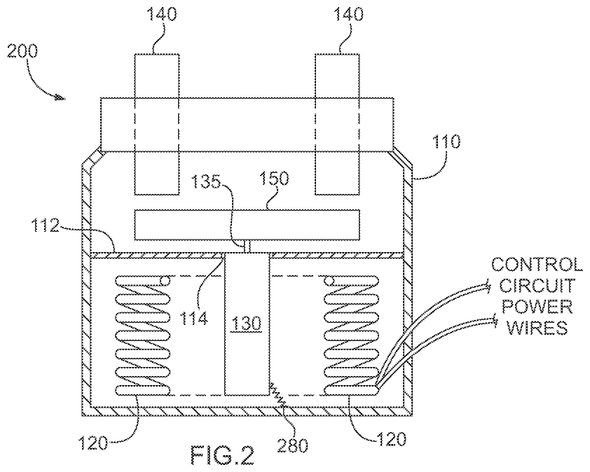

In a further exemplary configuration, the present invention may provide an electrical contactor 200 similar to that of the contactor 100 of FIG. 1, but having a conductive member 280 providing electrical communication between the plunger 130 and housing 110, FIG. 2. In such a configuration, it is not necessary to ground the housing 110 or to electrically isolate the main contact bridging bar 150 from the plunger 130. By electrically connecting the plunger 130 and housing 110, a voltage potential will not develop between the housing 110 in the plunger 130, and thus will not develop between the housing 110 and main contacts 140. Since the plunger 130 is movable, the conductive member 280 may be flexible and may include a spring, for example.

In a still further exemplary configuration, the present invention may provide an electrical contactor 300 also similar to that of the contactor 100 of FIG. 1, but having a conductive link 380 electrically connecting the main contacts 100 with the housing 110, possibly through a resistor so that the housing 110 stays at the same potential as the main contact 140 to which is connected. When the main contacts 140 are electrically connected to one another via the main contact bridging bar 150, both main contacts 140 will be at the same potential as the housing 110. The plunger 130 and main contact bridging bar 150 may be electrically isolated via the isolative material 135.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An electrical contactor, comprising:
a housing;
first and second electrical contacts disposed in an upper surface of the housing, the first and second electrical contacts disposed in spaced apart relation to one another by a selected distance measured in a plane of the upper surface;
a contact bar disposed below the upper surface at a location interior to the housing, the bar having a width at least as large as the selected distance and disposed in registration with each of the first and second electrical contacts at a location to permit simultaneous contact of the contact bar to each of the first and second electrical contacts; and
a plunger disposed in the housing and operably connected to the contact bar, the plunger movable relative to the upper plane in a direction perpendicular thereto, the plunger in electrical communication with the housing.

2. The electrical contactor according to claim 1, wherein the housing includes a lower compartment in which the plunger is disposed, the lower compartment including a ferrous wall having an aperture with the plunger disposed therein.

3. The electrical contactor according to claim 1, comprising a flexible conductive member connected to the plunger and the housing to provide electrical communication therebetween.

4. The electrical contactor according to claim 1, comprising electrically isolative material disposed between the contact bar and the plunger to electrically isolate the contact bar from the plunger.
